(19) United States
(12) Patent Application Publication
(10) Pub. No.: US 2008/0004890 A1
(43) Pub. Date: Jan. 3, 2008

(54) Interactive employment credential system and method

(76) Inventor: Dwayne Paul Hargroder, Lafayette, LA (US)

Correspondence Address: PERRET DOISE;A PROFESSIONAL LAW CORPORATION, P.O. DRAWER 3408, LAFAYETTE, LA, 70502-3408, US

(21) Appl. No.: 11/480,679

(22) Filed: Jul. 3, 2006

(51) Int. Cl. G06Q 10/00; G06Q 30/00

(52) U.S. Cl. 705/1

(57) ABSTRACT

An interactive employment credential system and method. The system comprises a database containing employee information, an authorization code for authorizing access to the database and a control device, operatively associated with the database, for presenting an employee weighted scores. The system further includes an employee processor operatively associated with the control device, and wherein the employee processor is capable of transmitting the authorization code to view the employee information. The system further comprises an employer processor that is capable of requesting authorization to download the employee information, including weighted scores computed from the system's algorithms.

### BACKGROUND OF THE INVENTION

This invention relates to the information technology industry for the systematic implementation of employee resource management. More specifically, but not by way of limitation, this invention relates to an interactive employment credential system and method.

As the insurance industry has incorporated the use of Medical Information Bureaus (MIB's) for Life and Health Insurance underwriting and Motor Vehicle Reports (MVR's) and claims history detail provided by “CLUE” for property and casualty insurance risks, this invention is designed to launch an internet site to provide on demand employee information on a prospective hire for employment underwriting by full disclosure of credentials as well as prior work history, performance and safety provisions.

The system herein disclosed consist of an interactive web-based information resource center for the management of employee credentials as well as prior work history and performance as reported by member companies. The system may include a certification program to award all companies that incorporate the system for the maintenance of current employees, new hires, as well as the reporting of all terminated employees with the recordation of exit interviews within the employee master file. The system allows for a second tier of performance information for employers and independent contractors in order to provide consumers with full disclosure of employer past performance and weighted scoring. The system may include the launching of a secure business web site through the incorporation of password protection and personal pin numbers to insure the privacy of each applicant's information and the restriction of use by unauthorized personnel. Such a system does not exist in the prior art.

Therefore, there is a need for an on-demand systematic employee management tool in order to improve the underwriting process of new hires and the management of existing employees and industry specific credentials. By virtue of the disclosed system, member companies will experience economic efficiencies from the reduction of Human Resources activity for new hire verification, reference checks on discharged employees, and insurance cost savings by the improved management practices and improved safety records by program implementation.

### SUMMARY OF THE INVENTION

In a first preferred embodiment, the system will provide baseline employment credentials and automatic updating of time sensitive information, such as 10 years employed in 2005 will automatically be 11 years in 2006, etc. Certifications and continuing education requirements will be updated instantaneously and reflect status of such requirements. The system can provide for automatic downloads with certification agencies in order to receive updated information electronically in an approved format.

An illustrative list of agencies that can communicate data includes: the State Real Estate Commission, Insurance Agency, Legal and Bar Associations, Barbers, Hair Dressers, State Board of Nursing, and other private approved certification agencies. The collected information will be available to all member companies through client authorization much like credit reports.

The database of employment records will then be available to member companies for a nominal fee. All employees in the system shall have identification cards with specified identification numbers and can be made available to the human resources departments to pull employment records within seconds. The system creates an employment database that will receive all information regarding that applicant's profession, duration of employment, special achievements/certifications and the current status of each. A real time resume that is constantly updated is not possible with the teachings of this invention.

In this first embodiment, a provision can be included to better educate the consumers about artesian contractors, like carpenters, roofers, electricians, etc. These members could have information about their job performance and personal references. The system could provide a template covering the vast array of occupations and certifications. The system could also provide a template to file on contractors for poor performance. This will be in the form of a complaint similar to a complaint form filed on an insurance company with the department of insurance.

In a second preferred embodiment, an interactive employment credential system is disclosed. The system comprises a database containing employee information, authorization means for authorizing access to the database and control means, operatively associated with the database, for presenting the employee information in a first format. The employee information is processed through an algorithm utilizing several hundred employment dynamics in order to compute an employer/employee weighted score. The interactive system provides for an authorization code for authorizing access to the database and control device, operatively associated with the database, in order for disclosure of score presentation. The system further includes an employee processor operatively associated with the control means, and wherein the employee processor is capable of transmitting authorization to view the employee information.

In this second embodiment, the system further comprises an employer processor in communication with the authorization means, and wherein the employer processor is capable of requesting authorization to download the employee information. The control means may contain means for requiring that the employer request includes payment of the request fee and means for requiring that the employee authorization includes payment of the request fee. In the most preferred embodiment, the first format of the employee information includes a weighted score performed by algorithm. The employee information may consist of health information, education information, criminal information, and/or professional certification information.

A method of providing employee information is also disclosed. The method comprises storing employee information on a database, transmitting authorization to view the employee information via an employee processor operatively associated with a control means, and authenticating and authorizing third parties access to the database. The method may further include presenting the employee information in a first format via the control means, and wherein the control means is operatively associated with the database.

The method may further comprise communicating an employer processor with the control means, and requesting authorization to download the employee information with the employer processor. In one embodiment, the step of requesting authorization to download employee information includes paying a request fee by the employer in order to view the employee information. Additionally, the step of transmitting authorization to make available employee information via an employee user processor may include paying a user fee by the employee in order to post the employee information to the database.

An advantage of the present disclosure is that companies would finally have an accountability program for the management of their employees and new hires with full disclosure. Another advantage is that workers will have to be accountable in order to maintain adequate weighted scores. It is believed that the workforce would be enhanced as they have a permanent record of performance.

Yet another advantage is that probation periods will be available for individuals that have experienced hard luck situations and have the opportunity to improve their scores. Another advantage is that companies could use these scores for merit pay and the incentive of good performers. Yet another advantage is that it is possible that companies that maintain a “threshold or average” employment of weighted scores of some predetermined level would receive special recognition and would be entitled to premium credits on large insurance programs.

Still yet another advantage is that employers will experience a reduced workload by not having to ever give a reference on an employee, and instead can log-on and download the appropriate file. Another advantage is that attorneys could use certain authorized information for discovery purposes. For instance, it will be possible to obtain credential information immediately about certifications, safety certification expirations, etc. Also, the system could be used in conjunction with verifying employment information on deadbeat dads.

Another advantage is that financial institutions will reduce loan losses by incorporating an additional underwriting tool that will provide emphasis on employment stability and will become a predictor of applicant's future ability to pay. Another advantage is that insurance cost will be reduced (for employers) by premium credits available for the employment of applicants with a threshold benchmark weighted score. As an example, XYZ Insurance Company will provide premium credits to workers compensation insurance coverage for all risk that maintain an employment workforce with a weighted score of 500 or greater. This commitment reflects improved applicant hires and less risk for loss. Yet another advantage to the insurance industry as they spread the risk amount insured. More insured contractors will benefit in the future due to decreased insurance cost for participation.

Still yet another advantage is that hospitals and health care organization will be protected by tracking all employees' specialization credentials and recurrent training as well as past performance by prior employment. CPR and other specialized credentials will be updated through association sponsored links, like Red Cross, etc. Also, hospitals that hire agency “pool” nurses for PRN (as needed) shifts will have complete documentation of these health care professionals. Hospitals are at risk due to poor background information on specific nurses that are sent at the last minute to simply cover nurse-patient ratios.

Yet another advantage is that commercial trucking firms will be able to protect themselves from CDL expirations and will have a management tool for all specific credential expirations as well as improved information on new hires, contract drivers and lease operations. The energy sector contains several industry specific training programs for various disciplines and the weighted score will become a source of acknowledgment and verification of completion by data links to these specific industry criteria. Full disclosure instantly will be very important to cyclical industries which have been known to hire large numbers of employees in a short period of time. The weighted score used in this invention will aid these cyclical industries with staffing.

Another advantage is that the system will assist employees to be better employees in order to maintain their score and achieve compensation incentives/promotions for enhanced work performance. Yet another advantage is that the system will assist employers and independent contractors to be better businesses, as they will be subject to full disclosure of performance. An applicant can use the web or call a telephone number with a proper pin identification and obtain information regarding contractors.

A feature of the present invention is that the system allows for a one-stop shop for recordation of employee history. Another feature is that good performer employees can be recognized quickly and rewarded, while poor performers will not. Another feature is that incentive pay will induce employees to achieve better scores. Yet another feature is that it is possible that employees with good weighted scores and marginal credit scores will be rewarded, as their ability to pay will be eased.

Another feature is that operational efficiencies will be experienced for all member companies with the reduction of human resource labor through the incorporation of automation and instantaneous file updating for minute-to-minute accuracy. Yet another feature is that an applicant can use the system as an updated resume. From the base line, all information will be updated instantaneously for real time accuracy. When a request exist for a resume, the applicatnt can reference the system. Once the applicant provides the personal identification code, access will be granted.

Another feature is that employer special achievement awards will be credited for enhancement of weighted scores, likewise, complaints filed against the employer will be harmful. The system seeks to achieve standardization among all industries and consumers will have access to information.

### BRIEF DESCRIPTION OF THE DRAWINGS

FIG. 1 is flow chart schematic depicting a first embodiment of the present novel system.

FIG. 2 is a flow chart schematic depicting a second embodiment of the present novel system.

FIG. 3 is a flow chart diagram depicting input factors for analysis and score weighing according to the present novel system.

### DETAILED DISCUSSION OF THE PREFERRED EMBODIMENTS

The system and method herein disclosed consist of an interactive web-based information resource center for the management of employee/employer credentials as well as prior work history and performance as reported by member resources. The site will assist employers in the management of their most important asset, their employees, as well as provide the public with full disclosure of employer's performance based scoring in order to protect the consumer from fraud and abuse. The created database collects employee credentials and the application of employer performance base scoring. The system may incorporate employee/employer dynamics as well as the management of industry specific requirements such as continuing education requirements, CPR certification for the medical industry, safety training for the energy sector, recurrent training for pilots, etc.

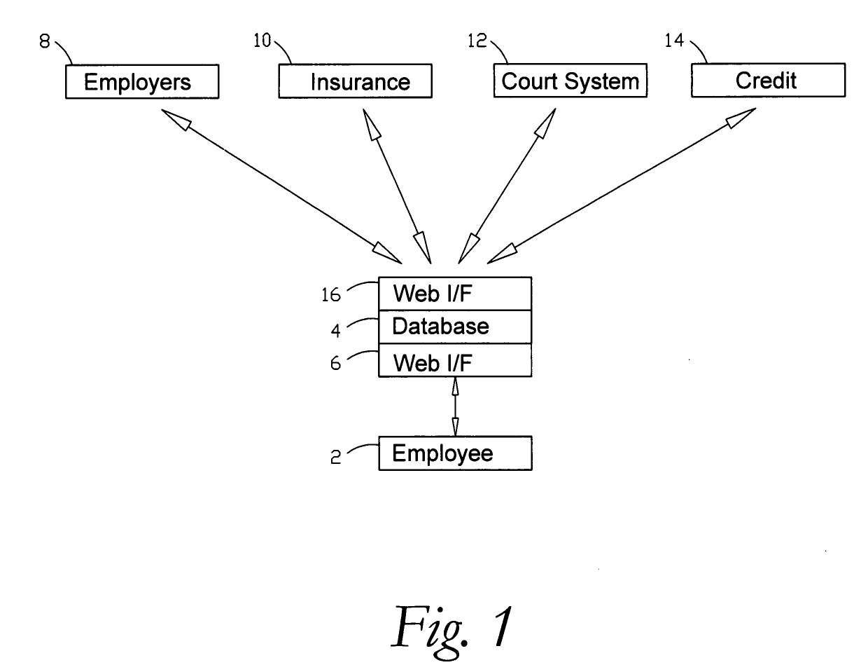

Referring now to FIG. 1, a flow chart schematic depicting a first embodiment of the present novel system will now be described. As shown in FIG. 1, an employee 2 would communicate with the database 4. In the most preferred embodiment, the employee 2 has an employee computer, also referred to as a user processor. The employee computer has means for communication with the Internet and the world wide web.

As per the teachings of the system, the database 4 contains the web interface means 6 so that the employee computer can communicate with the database. The employee computer may communicate (i.e. wireless transmission) data and information, including authorization to obtain data from various third party content custodians, as will be more fully explained later in the disclosure. The employee computer may also authorize payment of any fees required for use of the system.

FIG. 1 also depicts several entities that may provide information to the database 4 about the employee. For instance, employers may provide information to the database. Hence, employers 8 can provide this information to the database. FIG. 1 also depicts an insurance entity 10 that provides data for the database 4, a court system entity 12 that provides data for the database and a credit entity 14 that provides data for the database. This listing of entities is illustrative. In the most preferred embodiment, the employer entity 8, insurance entity 10, court system 12 and credit entity 14 will communicate with the database 4 via the Internet and world wide web, as shown by the web interface 16, and wherein the web interface 16 is operatively associated with the database 4. In this way, various entities can communicate data about an employee once the employee has submitted the proper authorization.

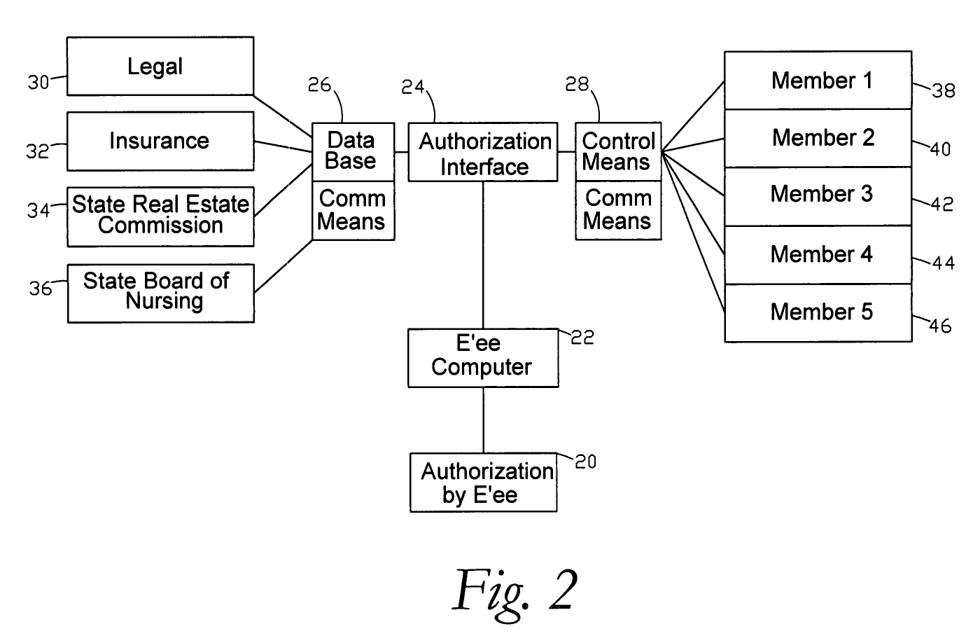

Referring now to FIG. 2, a flow chart schematic depicting a second embodiment of the present novel system will now be described. FIG. 2 is a higher level flow chart from the illustration of FIG. 1. In the embodiment of FIG. 2, an employee gives his authorization 20, and wherein the authorization is sent via the employee computer 22 to authorization interface 24. As depicted, the authorization interface 24 is operatively associated with the database 26 and with the control means 28.

FIG. 2 depicts several entities that will supply data and information to the database 26. More specifically, a legal entity (such as a court system) 30 is shown in communication with the database 26; an insurance entity (such as an insurance company) 32 is shown in communication with the database 26; a state real estate commission 34 is shown in communication with the database 26; and, a state board of nursing 36 is shown in communication with the database 26. The listing of entities is meant to be illustrative. The entities 30, 32, 34, and 36 will communicate with the database 26 via the world wide web in the most preferred embodiment.

Various member entities will be in communication with the database. FIG. 2 depicts five (5) member entities, but this listing is illustrative only. In one preferred embodiment, the member entities will pay a required fee to access the database 26 and any proprietary weighting score accomplished according to the teachings of the present invention. Hence, member entity 38 will communicate with the control means 28, which in turn will communicate with the authorization interface to check on authorization, and if there is authorization, then the member 38 will be allowed access to the data and information sought. FIG. 2 further shows the member 40 in communication with the control means, the member 42 in communication with the control means 28, the member 44 in communication with the control means 28, and the member 46 in communication with the control means 28. Members 40, 42, 44, and 46 receive authorization, information and data as mentioned earlier in the discussion of the member 38.

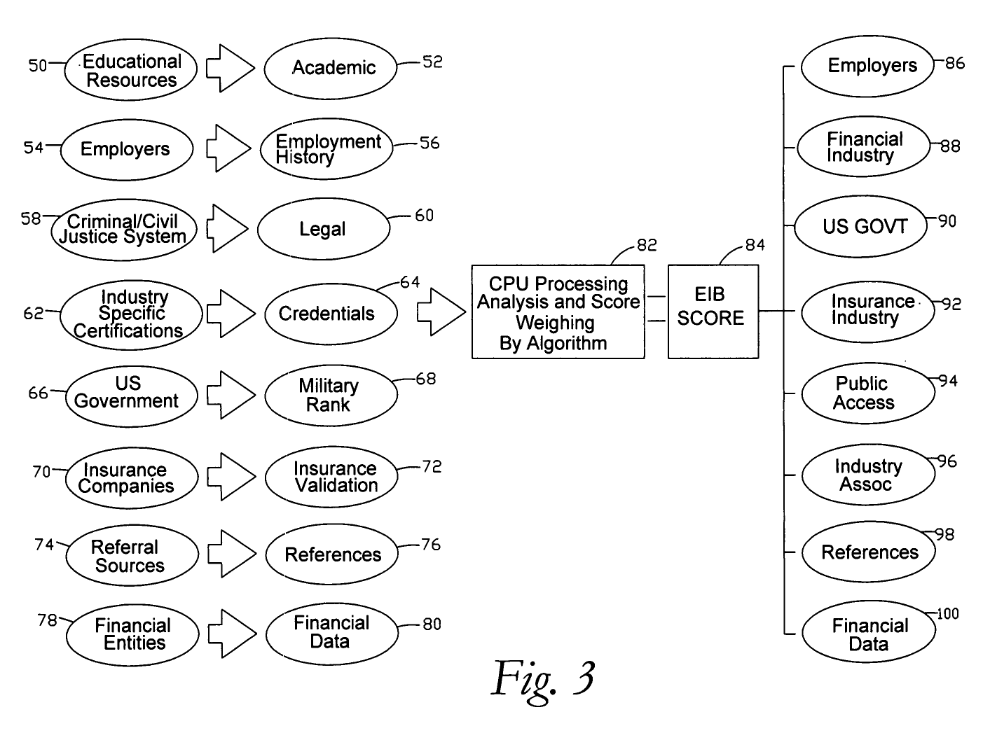

FIG. 3 is a flow chart diagram depicting input factors for analysis and score weighing according to the present novel system. Hence, a source of data can be educational resources 50, wherein academic records 52, such as high school and college transcripts, can be accessed. Another source of information may be from employers 54, wherein employment history 56, such as prior jobs and salary, can be accessed. Criminal/civil justice records can be accessed 58, wherein legal information 60, such as prior convictions, can be accessed. Another source of data is industry specific certification records 62, wherein certification information 64, such as professional licenses, can be accessed. Yet another source of data can be U.S Government information 66, such as military records 68, can be accessed. Information from insurance companies 70 can be gathered, such as insurance premium payment and validation 72. Yet another source of information can be referral sources 74, wherein specific references 76 can be accessed. Still yet another source of information is financial entities 78, and wherein financial data 80 can be accessed.

This information is sent to the central processing unit (CPU) 82 for processing, analysis and score weighting in accordance with the teachings of the present invention. The analysis and score weighing is done by algorithm. A weighted score 84 can then be assigned to that person. It is possible to give a weighted score for a particular factor (i.e. employment history), a group of factors (i.e. academic, military rank, and financial data), or all the factors. The weighted score 84 can then be disseminated to member entities, such as employers 86, a financial entity 88, a government entity 90, an insurance company 92, public access 94, an industry association 96, a specific court 98, or some other entity 100. The listing 86, 88, 90, 92, 94, 96, 98 and 100 is illustrative.

Although the present invention has been described with reference to preferred embodiments, workers skilled in the art will recognize that changes can be made in form and detail without departing from the spirit and scope of the invention, as well as any appropriate equivalents thereof

I claim:

1. An interactive employment credential system comprising:
a database comprising employee information;
authorization means for authorizing access to said database;
control means, operatively associated with said database, for presenting the employee information in a first format;
an employee processor operatively associated with said control means, and wherein said employee processor is capable of transmitting authorization to view said employee information.

2. The system of claim 1 further comprising:
an employer processor in communication with said authorization means, and wherein said employer processor is capable of requesting authorization to download said employee information.

3. The system of claim 2 wherein said control means comprises means for requiring that said employer request includes payment of a user request fee.

4. The system of claim 3 wherein said control means includes means for requiring that said employee authorization includes payment of an employee request fee.

5. The system of claim 4 said first format of said employee information includes a weighted score based on predetermined factors and calculated using a system.

6. The system of claim 5 wherein said employee information consisting of health information, education information, criminal information, professional certification information.

7. A method of providing employee information comprising:
storing employee information on a database;
transmitting authorization to view said employee information via an employee processor operatively associated with a control means;
authenticating and authorizing third parties access to said database;
presenting said employee information in a first format via said control means, and wherein said control means is operatively associated with said database.

8. The method of claim 7 further comprising:
communicating an employer processor with said control means;
requesting authorization to download said employee information with said employer processor.

9. The method of claim 8 wherein said the step of requesting authorization to download said employee information includes:
paying a request fee by said employer in order to view said employee information.

10. The method of claim 9 wherein said step of transmitting authorization to make available employee information via an employee user processor includes:
paying a user fee by said employee in order to post the employee information to the database.

11. The method of claim 10 said step of presenting said employee information in a first format includes utilizing an algorithm to calculate a weighted score of said employee information.

12. The method of claim 10 wherein said employee information is selected from the group consisting of a financial score, an academic score, an employment score, a character score, a medical score, a professional credential score, a reference score, a military score, a legal score or an insurance score.
